(19) United States
(12) Patent Application Publication
(10) Pub. No.: US 2007/0286248 A1
(43) Pub. Date: Dec. 13, 2007

(54) NONLINEAR OPTICAL MODULATOR

(75) Inventor: Jong-soo Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/755,078

(22) Filed: May 30, 2007

(30) Foreign Application Priority Data
Jun. 12, 2006 (KR) 10-2006-0052639

(51) Int. Cl. H01S 3/10

(52) U.S. Cl. 372/22

(57) ABSTRACT

A nonlinear optical modulator includes a resonator having an input mirror and an output mirror; a gain medium provided between the input mirror and the output mirror which generates a fundamental wave using light; a nonlinear material provided between the gain medium and the output mirror which generates a predetermined harmonic wave from the fundamental wave; a thermostat that controls temperature of the nonlinear material; and an electric field generator that applies an electric field to the nonlinear material.

### CROSS-REFERENCE TO RELATED APPLICATIONS

This application claims priority from Korean Patent Application No. 10-2006-0052639 filed on Jun. 12, 2006, the disclosure of which is incorporated herein by reference in its entirety.

### BACKGROUND OF THE INVENTION

1. Field of the Invention

Apparatuses of the present invention relate to a nonlinear optical modulator, and more particularly, to a nonlinear optical modulator comprising a gain medium and a nonlinear material within a resonator.

2. Description of the Related Art

In general, a material has linear polarization by interaction with an electromagnetic wave or a light wave, but a nonlinear material such as a nonlinear single crystal may generate harmonic waves having an integral multiple of a fundamental frequency. Energy is exchanged between electric fields having different frequencies. One application of this phenomenon is a harmonic producer, which is represented by a second harmonic producer that generates a harmonic wave having a doubled fundamental frequency.

If the amplitude of a light wave incident into a nonlinear material is sufficiently large, an electric dipole will have a nonharmonic oscillation. This implies that light output from the nonlinear material has various harmonic components as well as a fundamental frequency. In general, since electric potentials of charges are symmetrical if a crystal structure of the nonlinear material has inversion symmetry, the minimal one of nonlinear polarizations derived from a sum of electric diploes becomes a third harmonic component. In a nonlinear material having no inversion symmetry, there exists a second harmonic component. Emission of light by polarizations oscillating with a frequency twice of fundamental frequency is called second harmonic generation.

The above-mentioned harmonic producer cools or heats nonlinear material using a temperature regulator for phase matching between a fundamental wave and harmonic waves. However, it takes a time for the harmonic producer to obtain sufficient light output while cooling or heating. That is, the harmonic producer may not obtain the light output in real time.

### SUMMARY OF THE INVENTION

Exemplary embodiments of the present invention overcome the disadvantages described above and other disadvantages not described above. Also, the present invention is not required to overcome the disadvantages described above, and an exemplary embodiment of the present invention may not overcome any of the problems described above.

Accordingly, an aspect of the present invention provides a nonlinear optical modulator capable of obtaining light output stably and efficiently.

The foregoing and/or other aspects of the present invention can be achieved by providing a nonlinear optical modulator comprising: a resonator comprising an input mirror and an output mirror; a gain medium provided between the input mirror and the output mirror which generates a fundamental wave using light; a nonlinear material provided between the gain medium and the output mirror which generates a predetermined harmonic wave from the fundamental wave; a thermostat that controls temperature of the nonlinear material; and an electric field generator that applies an electric field to the nonlinear material.

According to a non-limiting exemplary embodiment of the present invention, matching of refraction indexes of the fundamental wave and the harmonic wave is obtained by the electric field applied from the electric field generator.

According to a non-limiting exemplary embodiment of the present invention, the output mirror is formed integrally with the nonlinear material.

According to a non-limiting exemplary embodiment of the present invention, the nonlinear optical modulator further comprises: a light source that supplies light to the gain medium; and a condenser lens that is provided between the light source and the resonator.

According to a non-limiting exemplary embodiment of the present invention, the light source comprises a diode laser or a solid-state laser.

According to a non-limiting exemplary embodiment of the present invention, the harmonic wave comprises at least one of a visible ray and an ultraviolet ray.

According to a non-limiting exemplary embodiment of the present invention, the nonlinear material comprises at least one of an inorganic single crystal and a semiconductor material.

According to a non-limiting exemplary embodiment of the present invention, the gain medium comprises Nd:YAG.

According to a non-limiting exemplary embodiment of the present invention, the nonlinear material comprises LiNbO₃, LiTaO₃, NH₄H₂PO₄, KTiOPO₄ or KH₂PO₄.

According to a non-limiting exemplary embodiment of the present invention, the nonlinear material comprises GaAs or InP.

The foregoing and/or other aspects of the present invention can be achieved by providing a nonlinear optical modulator system comprising: a first resonator comprising a first input mirror and a first output mirror; a second resonator comprising a second input mirror and a second output mirror; a light source which provides input light to the first resonator; a first condenser lens which condenses light emitted from the light source disposed between the light source and the first resonator; a second condenser lens which condenses light output from the first resonator disposed between the first resonator and the second resonator; a thermostat in communication with the second resonator which controls a temperature in the second resonator; an electric field generator in communication with the second resonator which generates an electric field in the second resonator; and a photo detector which detects light output from the second resonator.

According to a non-limiting exemplary embodiment of the present invention, the first resonator further comprises: a gain medium disposed between the first input mirror and the first output mirror which generates a fundamental wave using light; and a nonlinear material disposed between the gain medium and the output mirror which generates a predetermined harmonic wave from the fundamental wave.

According to a non-limiting exemplary embodiment of the present invention, the nonlinear material comprises at least one of an inorganic single crystal and a semiconductor material.

According to a non-limiting exemplary embodiment of the present invention, the second resonator further comprises a nonlinear material disposed between the gain medium and the output mirror which generates a predetermined harmonic wave from the fundamental wave.

According to a non-limiting exemplary embodiment of the present invention, the thermostat controls temperature of the nonlinear material comprising a second resonator.

According to a non-limiting exemplary embodiment of the present invention, the electric field generator applies the electric field to the nonlinear material comprising the second resonator.

According to a non-limiting exemplary embodiment of the present invention, the second resonator further comprises a gain medium disposed between the second input mirror and the second output mirror which generates a fundamental wave using light.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is a schematic view of a nonlinear optical modulator according to a first embodiment of the present invention;

FIG. 2 is a graph illustrating a light output depending on temperature according to a first exemplary embodiment of the present invention;

FIG. 3 is a graph illustrating a light output depending on application of an electric field according to the first exemplary embodiment of the present invention;

FIG. 4 is a schematic view of a nonlinear optical modulator according to a second exemplary embodiment of the present invention; and

FIG. 5 is a schematic view of a nonlinear optical modulator according to a third exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to like elements throughout. The exemplary embodiments are described below so as to explain the present invention by referring to the figures.

The like elements will be described for a first exemplary embodiment and may not be further described for other exemplary embodiments.

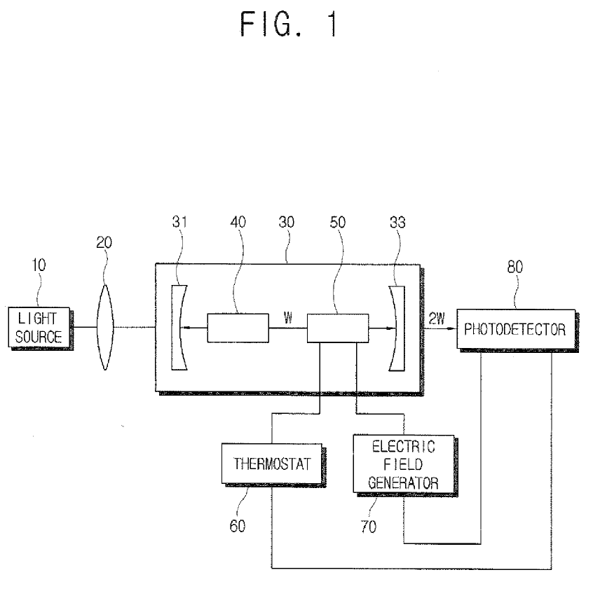

FIG. 1 is a schematic view of a nonlinear optical modulator according to a first exemplary embodiment of the present invention.

As shown in FIG. 1, a nonlinear optical modulator according to a first exemplary embodiment of the present invention comprises a light source 10, a condenser lens 20, a resonator 30, a thermostat 60, an electric field generator 70 and a photodetector 80. The resonator 30 incorporates an input mirror 31, an output mirror 33, a gain medium 40, and nonlinear material 50 for optical resonance.

The light source 10 provides light to the gain medium 40 in the resonator 30. The light source may include, but is not limited to, a solid-state laser to output light having a wavelength of 1064 nm or 946 nm, a diode laser to output light having a wavelength of 780 nm, or a semiconductor laser to output light having a wavelength of 800 nm or more.

When the nonlinear optical modulator is used for high power optical instruments such as an optical pickup device, the light source 10 may output a continuous light wave. When the nonlinear optical modulator is used for medical appliances, the light source 10 may output a pulsed light wave. Light emitted from the light source 10 is pumped in the gain medium 40.

The condenser lens 20 condenses the light emitted from the light source 10. The condenser lens 20 compensates for deficiency of the light intensity used for producing a harmonic wave as an output light. Output of a second harmonic wave is proportional to a multiplication of a secondary nonlinear coefficient by the intensity of incident light. Accordingly, when the second harmonic wave is produced as output light with a nonlinear material having a small secondary nonlinear coefficient, the condenser lens 20 may be used for increasing the intensity or power of light.

In the resonator 30, the input mirror 31 and the output mirror 33 have high reflectivity for a fundamental wave. The nonlinear material 50 and the gain medium 40 are disposed between the mirrors 31 and 33. The input mirror 31 and the output mirror 33 together define an optically-confined resonance cavity. The maximum resonance of the fundamental wave is possible only when the cavity is provided appropriately. In other words, the second harmonic wave can be effectively obtained only when the fundamental wave of high intensity passes through the nonlinear material 50 doubling the frequency of the fundamental wave while reflecting back and forth between the input mirror 31 and the output mirror 33. Some of the fundamental wave may be output through the output mirror 33, but most of the fundamental wave is confined and resonates in the resonator 30. Also, a third harmonic wave or other higher harmonic waves may be produced by interaction of the fundamental wave with the second harmonic wave.

In this exemplary embodiment, the gain medium 40, which is provided in the resonator along with the nonlinear material 50, serves to reduce optical loss and increase output efficiency of light.

The gain medium 40 absorbs light input into the resonator 30 and outputs an amplified fundamental wave to the nonlinear material 50. The gain medium 40 may comprise, but is not limited to, Nd:YAG

The nonlinear material 50 produces harmonic waves having integral multiples of the frequency of the fundamental wave by decreasing the wavelength of the fundamental wave pumped in the gain medium 40. For example, a fundamental wave with a frequency ω may be modulated into a second harmonic wave with a frequency 2ω or a third harmonic wave with a frequency 3ω.

The nonlinear material 40 may comprise, but is not limited to, an inorganic single crystal such as LiNbO₃, LiTaO₃, NH₄H₂PO₄, KTiOPO₄, KH₂PO₄, or a semiconductor material such as GaAs, InP or the like, which has a large electro-optical coefficient. In recent years, chromophores having a large dipole moment to have a large electro-optical coefficient have been developed, and nonlinear electro-optical polymers, which are a combination of these chromophores and polymers, have come into the spotlight.

A wave output from the nonlinear material 50 may have wavelength bands of a visible ray, an ultraviolet ray or an infrared ray. If the wavelength of the fundamental wave is 1064 nm, a green visible ray with a wavelength of 532 nm will be output. If the wavelength of the fundamental wave is 880 nm, a blue visible ray with a wavelength of 440 nm will be output. A harmonic wave having an integral multiple of the fundamental frequency may be obtained depending on the kind of the nonlinear material 50, temperature regulation and variation of an electric field. To this end, phase matching between harmonic waves output from the nonlinear material 50 is required.

Although not shown, a bluster plate for polarization of the fundamental wave may be provided between the gain medium 40 and the nonlinear material 50. In this case, the bluster plate is provided to make an inclined angle of 45° between its incidence surface and an extra ordinary axis of the nonlinear material 50.

The thermostat 60 cools or heats the nonlinear material 50 to stabilize a harmonic wave output from the nonlinear material 50. The nonlinear material 50 has a characteristic of being sensitive to thermal variation due to its temperature-dependent birefringence. In the case of a nonlinear optical modulator using the nonlinear material 50, production of harmonic waves is accompanied by considerable heat production. Accordingly, methods for thermally stabilizing light output of the nonlinear optical modulator have been devised. The thermostat 60 induces phase matching by regulating the temperature of the nonlinear material 50 to obtain stabilized light output. The thermostat 60 may comprise, but is not limited to, a Peltier element as a thermoelectric cooling element.

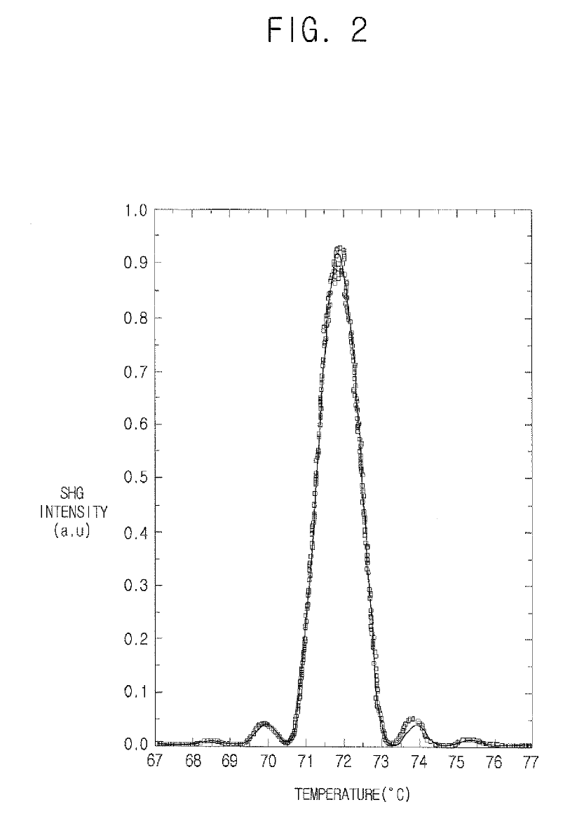

FIG. 2 is a graph showing a temperature-dependent light output according to the first exemplary embodiment of the present invention. In the graph of FIG. 2, a harmonic wave used is a second harmonic wave, and a solid line indicates a second harmonic wave output in ideal phase matching. The nonlinear material 50 used is 2MgO:LN, which is produced by doping MgO into LiNbO₃. It can be seen from the graph that the ideal phase matching is obtained at temperature of about 70° C.

The stabilized light output in the phase matching may be confirmed through analysis of the intensity of light detected by the photo detector 80. Overlap of a profile of the second harmonic wave with the solid line means that smooth phase matching of the second harmonic wave through the nonlinear material 50 is achieved, that is, the light output is stabilized. Thus, the thermostat 60 is so controlled that the profile of the second harmonic wave overlaps the solid line.

Such temperature control is accomplished by a control circuit that analyzes the intensity of light detected by the photo detector 80, compares the analyzed intensity of light with a specified optimal light intensity profile, and heats or cools the nonlinear material 50 based on a result of the comparison.

According to an alternative exemplary embodiment, the second harmonic wave output remains constant and the temperature of the nonlinear material 50 located within the resonance section is precisely regulated to stabilize the light output.

The electric filed generator 70 applies an electric filed to the nonlinear material 50. Since it takes a predetermined time to obtain sufficient light output while heating or cooling the nonlinear material 50, the light output may not be obtained in real time and may be perturbed depending on the temperature of the nonlinear material 50. In this case, the birefringence of the nonlinear material 50 is adjusted by applying an electric field to the nonlinear material 50. The phase matching of the harmonic waves can be achieved by applying the electric field to the nonlinear material 50 accompanied with the temperature regulation. Since the nonlinear material 50 has an electric field-dependent birefringence as well as a temperature-dependent birefringence, a refractive index of the fundamental wave may be matched with refractive indexes of the harmonic waves by applying the electric field to the nonlinear material 50.

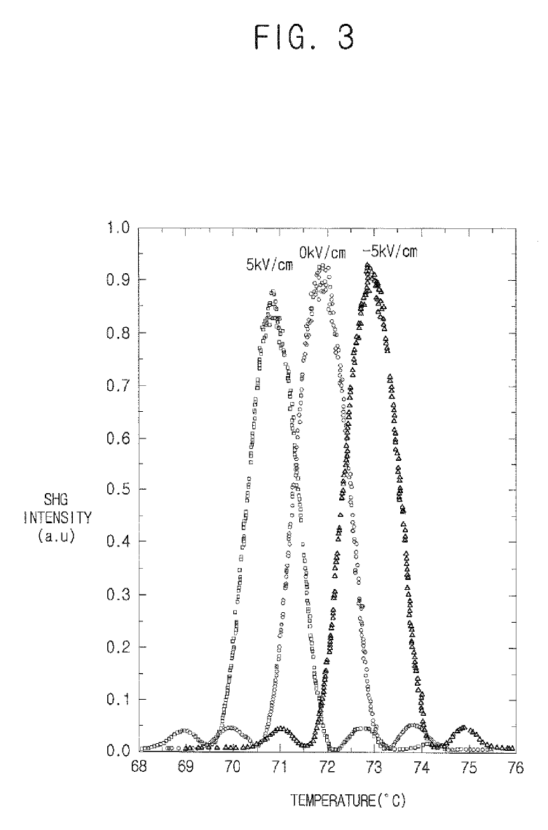

FIG. 3 is a graph illustrating a light output depending on application of an electric field according to the first exemplary embodiment of the present invention. FIG. 3 shows light outputs when no electric field is applied to the nonlinear material 50, when an electric field of 5 kV/cm is applied to the nonlinear material 50, and when an electric field of −5 kV/cm is applied to the nonlinear material 50. It can be seen from this graph that the light output has a light output profile similar to that shown in FIG. 2 when no electric field is applied to the nonlinear material 50, while the temperature at which phase matching is obtained is varied when an electric field is applied to the nonlinear material 50. Specifically, when the electric field of 5 kV/cm is applied to the nonlinear material 50, phase matching is obtained at temperature of about 70.5° C., and, when the electric field of −5 kV/cm is applied to the nonlinear material 50, phase matching is obtained at temperature of about 73.5° C. It can be seen from the graph of FIG. 3 that phase matching conditions of the nonlinear material 50 are varied depending on the temperature and the electric field. The electric field may be adjusted at predetermined temperature while the intensity of the harmonic waves detected by the photodetector 80 is analyzed.

The temperature regulation and the electric field application are not limited to the above-described order. The temperature regulation and the electric field application may be performed simultaneously or sequentially without any limitation. In addition, after the variation of the temperature is stabilized, an electric field may be applied to the nonlinear material 50 to control generation of harmonic waves.

A filter to remove the fundamental wave output from the resonator 30 and pass the second harmonic wave may be further provided between the output mirror 33 and the photodetector 80. That is, only a desired harmonic wave may be detected using the filter.

The nonlinear optical modulator according to this exemplary embodiment may output a fundamental wave having half or one-third of a fundamental wavelength, and accordingly, may be applicable to, for example, but not limited to, optical pickup devices, laser printers, optical measuring instruments, and other various devices requiring wavelength conversion.

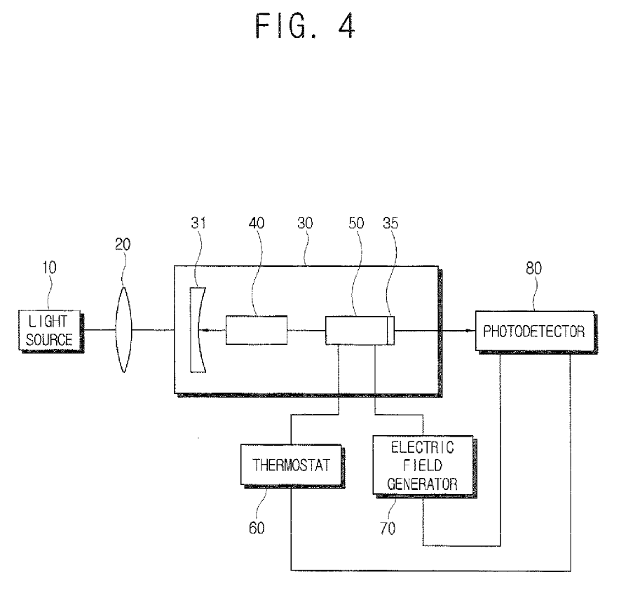

FIG. 4 is a schematic view of a nonlinear optical modulator according to a second exemplary embodiment of the present invention, in which other elements except the output mirror 35 are the same as in the first exemplary embodiment.

The resonator in the first exemplary embodiment uses two mirrors which are mounted on a separate optical mount independent of the nonlinear material, which may result in an increase in the size of the resonator and mechanical instability.

Thus, in the second exemplary embodiment, the resonator 30 has the input mirror 31 while the nonlinear material 50 is integrated with an output mirror 35.

The output mirror 35 is formed on one end surface of the nonlinear material 50 after processing and coating the nonlinear material 50 with a dielectric. In this case, the fundament wave may exist as a stationary wave in the resonator 30. The one processed side of the nonlinear material 50 on which the output mirror 35 is formed may comprise a curved surface like a portion of a sphere.

The input mirror 31 is separated from the nonlinear material 50 and may have high frequency stability and continuous frequency scan characteristics when the input mirror 31 is disposed on a piezoelectric element to allow high speed frequency scanning.

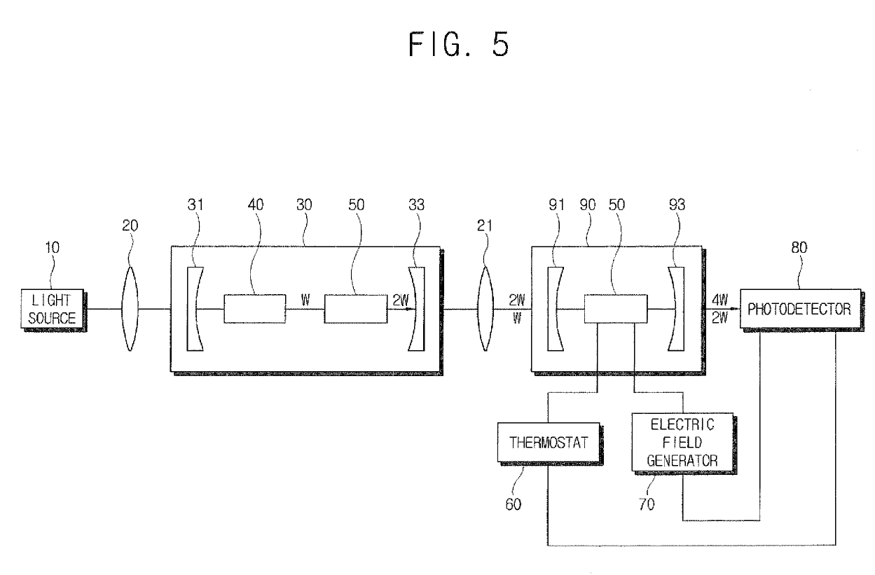

FIG. 5 is a schematic view of a nonlinear optical modulator according to a third embodiment of the present invention.

As shown in FIG. 5, the nonlinear optical modulator according to the third exemplary embodiment of the present invention comprises two resonators, that is, a first resonator 30 and a second resonator 90 connected in series to the first resonator 30. Two or more resonators may be used to obtain a desired harmonic wave.

For example, a fourth harmonic wave of the fundamental wave having a frequency of 4ω is obtained by inputting a second harmonic wave having a frequency of 2ω from the first resonator 30 to the second resonator 90.

A second condenser lens 21 to condense the second harmonic wave is provided between the first resonator 30 and the second resonator 90. The second resonator 90 comprises an input mirror 91 and an output mirror 93 and the nonlinear material 50 is formed between both mirrors 91 and 93. The thermostat 60 and the electric field generator 70 are connected to the nonlinear material 50. The nonlinear material 50 provided inside the second resonator 90 may be the same as the nonlinear material 50 provided inside the first resonator 30 and may comprise material different from the nonlinear material 50 provided inside the first resonator 30 depending on a harmonic wave desired by a user.

As shown in FIG. 5, the second resonator 90 does not include a gain medium 40. This corresponds to a case that the intensity of the second harmonic wave output from the first resonator 30 is sufficient. Alternatively, the second resonator 90 may also include the gain medium 40.

As described above, the light output from the first resonator 30 may include the fundamental wave having no change in frequency as well as the second harmonic wave. When the fundamental wave passes through the second resonator 90, the second harmonic wave having wavelength half of the fundamental wave frequency may be obtained, and a third harmonic wave may be also obtained by interaction of the second harmonic wave with the fundamental wave.

In this manner, when a user controls the thermostat and the electric field generator with one or more resonators, the user can obtain desired higher-order harmonic waves without difficulty.

As apparent from the above description, the present invention provides a nonlinear optical modulator, which is capable of obtaining light stably and efficiently.

Although a only few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A nonlinear optical modulator comprising:
a resonator comprising an input mirror and an output mirror;
a gain medium provided between the input mirror and the output mirror which generates a fundamental wave using light;
a nonlinear material provided between the gain medium and the output mirror which generates a specified harmonic wave from the fundamental wave;
a thermostat that controls temperature of the nonlinear material; and
an electric field generator that applies an electric field to the nonlinear material.

2. The nonlinear optical modulator according to claim 1, wherein refraction indexes of the fundamental wave and the harmonic wave are matched by the electric field applied from the electric field generator.

3. The nonlinear optical modulator according to claim 2, wherein the output mirror is formed integrally with the nonlinear material.

4. The nonlinear optical modulator according to claim 1, wherein the output mirror is formed integrally with the nonlinear material.

5. The nonlinear optical modulator according to claim 1, further comprising:
a light source that supplies light to the gain medium; and
a condenser lens provided between the light source and the resonator.

6. The nonlinear optical modulator according to claim 5, wherein the light source comprises a diode laser or a solid-state laser.

7. The nonlinear optical modulator according to claim 1, wherein the harmonic wave comprises at least one of a visible ray and an ultraviolet ray.

8. The nonlinear optical modulator according to claim 1, wherein the nonlinear material comprises at least one of an inorganic single crystal and a semiconductor material.

9. The nonlinear optical modulator according to claim 1, wherein the gain medium comprises Nd:YAG.

10. The nonlinear optical modulator according to claim 1, wherein the nonlinear material comprises LiNbO₃, LiTaO₃, NH₄H₂PO₄, KTiOPO₄ or KH₂PO₄.

11. The nonlinear optical modulator according to claim 1, wherein the nonlinear material comprises GaAs or InP.

12. A nonlinear optical modulator system comprising:
a first resonator comprising a first input mirror and a first output mirror;
a second resonator comprising a second input mirror and a second output mirror;
a light source which provides input light to the first resonator;
a first condenser lens which condenses light emitted from the light source disposed between the light source and the first resonator;
a second condenser lens which condenses light output from the first resonator disposed between the first resonator and the second resonator;
a thermostat in communication with the second resonator which controls a temperature in the second resonator;
an electric field generator in communication with the second resonator which generates an electric field in the second resonator; and
a photo detector which detects light output from the second resonator.

13. The nonlinear optical modulator system of claim 12, wherein the first resonator further comprises:
a gain medium disposed between the first input mirror and the first output mirror which generates a fundamental wave using light; and
a nonlinear material disposed between the gain medium and the output mirror which generates a predetermined harmonic wave from the fundamental wave.

14. The nonlinear optical modulator system according to claim 13, wherein the nonlinear material comprises at least one of an inorganic single crystal and a semiconductor material.

15. The nonlinear optical modulator system of claim 12, wherein the second resonator further comprises a nonlinear material disposed between the gain medium and the output mirror which generates a predetermined harmonic wave from the fundamental wave.

16. The nonlinear optical modulator system of claim 15, wherein the thermostat controls temperature of the nonlinear material comprising a second resonator.

17. The nonlinear optical modulator system of claim 15, wherein the electric field generator applies the electric field to the nonlinear material comprising the second resonator.

18. The nonlinear optical modulator system of claim 15, wherein the second resonator further comprises a gain medium disposed between the second input mirror and the second output mirror which generates a fundamental wave using light.
